(19) United States
(12) Patent Application Publication
(10) Pub. No.: US 2025/0008949 A1
(43) Pub. Date: Jan. 9, 2025

(54) MICRONIZED WAX AND SILICONE AGROCHEMICAL FORMULATION

(71) Applicant: SYNGENTA CROP PROTECTION AG, Basel (CH)

(72) Inventors: Nicola GIRI, Greensboro, NC (US); Rufai IBRAHIM, Greensboro, NC (US); Jinsong LEE, Greensboro, NC (US)

(73) Assignee: SYNGENTA CROP PROTECTION AG, Basel (CH)

(21) Appl. No.: 18/706,838

(22) PCT Filed: Oct. 26, 2022
(86) PCT No.: PCT/EP2022/079860

§ 371 Date: May 2, 2024

(30) Foreign Application Priority Data
Nov. 2, 2021 (EP) 21206017.2

(51) Int. Cl. A01N 25/04; A01P 21/00

(52) U.S. Cl. CPC A01N 25/04; A01P 21/00

(57) ABSTRACT

Composition having a micronized wax, a silicone emulsion, and a wetting agent. The compositions can be used for treating seeds.

### CROSS-REFERENCE TO RELATED APPLICATIONS

This application claims priority to EP21206017.2 filed Nov. 2, 2022, the entire contents of which are incorporated by reference.

The present invention relates to agrochemical compositions, and in particular compositions for treatment of seeds, as well as the preparation of such compositions and a method of using such compositions.

### BACKGROUND

In general, prior to planting, seeds can be treated with agrochemicals in order to control insect damage, fungal/microbial damage, etc. which results after planting of the seeds. Such treatments can be applied to the exterior of the seed or plant propagation material. However, treatments for coating propagation material must meet various parameters to be effective. For example, formulations which do not properly adhere to the propagation material can separate from the propagation material resulting in a build up of coating material in the planting equipment thereby increasing maintenance and damage to the equipment or contaminating the surrounding area.

Other challenges include attenuation of the rate of planting in the planting process. To plant high volumes, many propagation materials are planted mechanically. Such mechanical systems rely on flowability of the propagation material. That is, propagation material must be able to move through the planting equipment without adhering to the equipment or other propagation material. When propagation material adheres to equipment or each other, gaps in planting or overplanting may result. Traditional lubricants include powders such a talc, mica, etc., however, these powder are messy and can result in increased maintenance of planting equipment or contamination of the surrounding area.

Accordingly, there remains a need for treatments for plant propagation materials which effectively adhere to the propagation and allow flowability of the propagation material during planting.

### SUMMARY

These and other problems are solved using a composition having an agrochemical active ingredient, a micronized wax, and a silicone emulsion.

Embodiments of the invention are directed to a method applying a composition having an agrochemical active ingredient, a micronized wax, a silicone emulsion, and a wetting agent to a plant propagation material, wherein the composition is formulated as a seed treatment.

### BRIEF DESCRIPTION OF THE DRAWINGS

FIG. 1A provides data from an FT4 flowability test, and FIG. 1B shows the statistical analysis.

FIG. 2A provides data from an FT4 flowability test, and FIGS. 2B-C show the statistical analysis.

FIGS. 3A-B show the results from dynamic mechanical analysis testing.

FIG. 4 shows the results from funnel flow testing.

FIG. 5A provides data from an FT4 flowability test, and FIG. 5B shows the statistical analysis

FIG. 6A shows the results from funnel flow testing, and FIG. 6B shows the statistical analysis.

FIGS. 7A-C shows the results from funnel flow testing.

FIGS. 8A-B shows the results from singulation testing in a Kinzer brush meter, and FIG. 8C shows the statistical analysis.

FIGS. 9A-D shows the results from singulation testing in Kinzer plantability testing.

### DETAILED DESCRIPTION

Embodiments are directed to a composition having an agrochemical active ingredient, a micronized wax, and a silicone emulsion. In certain embodiments, the composition is formulated as a seed treatment. The micronized wax can be carnauba wax or a derivative thereof. As used herein, derivatives of carnauba waxes are products which are made or derived from carnauba wax. In general, this means starting with carnauba wax and further modifying the product. For example, a wax emulsion using carnauba wax is a carnauba wax derivative. Alternatively, the micronized wax can have a composition comprising: about 40% aliphatic esters (C26-C30), about 21% diesters of 4 hydroxycinnamic acid, about 13% ω-hydroxycarboxylic acids, and about 12% fatty alcohols. In certain embodiments, the average particle size of the micronized wax is 1 to 20 μm

In general, embodiments include compositions where the micronized wax is present between about 1 to 15% w/w. In other embodiments, the micronized wax can be present between about 2 to 10% w/w. Alternatively, the micronized wax can be present between about 4 to 6% w/w.

In certain embodiments, the silicone emulsion is present at about 0.05 to 4% w/w. Alternatively, the silicone emulsion can be present at about 1% w/w.

Specific embodiments include a method of applying a composition having a micronized wax, a silicone emulsion to a seed, wherein the composition is formulated as a seed treatment.

A silicone emulsion refers to a fine dispersion of droplets containing silicone in a continuous phase in which the silicone is not soluble or miscible. The term silicone generally refers to macromolecular compounds that contain atoms of silicon, carbon, and other elements in the repeating unit of the macromolecule. Preferred embodiments of the silicones include polyorganosiloxanes. Specific examples include polydimethylsiloxane. The silicone used in the present composition have a molecular weight of, for example, of at least 350 g/mol, at least 1,000 g/mol, at least 5,000 g/mol, at least 6,000 g/mol, or at least 10,000 g/mol. In some embodiments, the silicone can have a molecular weight of from about 350 to 100,000 g/mol, about 1,000 to about 25,000 g/mol, about 5,000 to about 15,000, or about 10,000. In specific embodiments, the viscosity of the silicone emulsion is from about 100 to 60,000 cSt, in specific embodiments, from about 350 to 50,000 cSt, or from about 1,000 to 12,500 cSt. In specific embodiments the viscosity is about 10,000 cSt. The amount of silicone in the emulsion can be from about 20 to 70% w/w, in certain embodiments, from about 35 to 65% w/w, or in some embodiments, about 50%.

### Agrochemicals

Agrochemicals include, but are not limited to selective herbicides, fungicides, other insecticides, bactericides, insect growth regulators, plant growth regulators, nematicides, molluscicides or mixtures of several of these preparations. In general, the amount of fungicide, insecticide or other ingredients used in the seed treatment are employed in amounts that do not inhibit germination of the seed or cause phytotoxic damage to the seed. The total amount of active ingredients is generally in the range of from about 0.5% to about 50% w/w, more specifically, from 2 to about 20% w/w. In specific embodiments, the active ingredients are from about 3 to about 10% w/w.

Fungicides useful in the present compositions include any agent useful for the prevention or treatment of fungal pests. Such fungicides may be particularly useful in controlling certain phytopathogenic fungi, and provide high fungicidal activity and relatively low phytotoxicity.

More specifically, fungicides useful in the compositions can include, but are not limited to, diazole, triazole, phenylpyrrole, strobilurin, carboxamide, carboxanilide, especially ortho-substituted carboxanilide, carbamate, anilinopyrimidine, phenoxyquinoline, benzimidazole, systemic and phenylamide fungicides. More particularly, the present invention includes the use of systemic, strobilurin, and phenylpyrrole type fungicides. Even more particularly, the present invention includes the use of phenylpyrrole type fungicides.

Diazole fungicides that are useful include imidazoles and pyrazoles. Examples of diazole fungicides that are useful include, without limitation, imazalil, oxpoconazole, pefurazoate, prochloraz, and trifulmizole. Mixtures of such diazoles can also be used.

Examples of triazole fungicides that are preferred for use include, without limitation, amitrol, azaconazole, bitertanol, bromuconazole, climbazole, clotrimazole, cyproconazole, diclobutrazol, difenoconazole, diniconazole, diniconazole-M, epoxiconazole, etaconazole, fenbuconazole, fluquinconazole, fluotrimazole, flusilazole, flutriafol, furconazole, furconazole-cis, hexaconazole, imibenconazole, ipconazole, metconazole, myclobutanil, paclobutrazol, penconazole, propiconazole, quinconazole, simeconazole, tebuconazole, tetraconazole, triadimefon, triadimenol, triazbutil, triticonazole, and 1-(4-fluorophenyl)-2-(1H-1,2,4-triazole-1-yl)ethanone. Mixtures of such triazoles can also be used.

Examples of strobilurin-type fungicides that are useful include, without limitation, azoxystrobin, dimoxystrobin, famoxadone, fluoxastrobin, kresoxim-methyl, metominostrobin, picoxystrobin, pyraclostrobin, and trifloxystrobin. Mixtures of strobilurin type fungicides can also be used. Mixtures of strobilurin-type fungicidies can also be used.

Examples of phenylpyrrole type fungicides that are useful include, without limitation, fludioxonil and fenpiclonil. Mixtures of phenylpyrrole-type fungicidies can also be used.

Examples of amide and carboxamide type fungicides that are useful include, without limitation, boscalide, carboxin, fenfuram, flutolanil, furametpyr, mepronil, oxycarboxin, mandipropamid, and thifluzamide. Mixtures of amide and carboxamide-type fungicidies can also be used.

Examples of carboxanilide type fungicides include, especially, ortho-substituted carboxanilide type fungicides. Fungicides in this class include, without limitation, 3-difluoromethyl-1-methyl-1H-pyrazole-4-carboxylic acid (2-bicyclopropyl-2-yl-phenyl)-amide and the isomers thereof; and 3-difluoromethyl-1-methyl-1H-pyrazole-4-carboxylic acid [9-isopropyp-1,2,3,4-tetrahaydro-1,4-methano-naphthalen-5-yl]-amide, and the isomers thereof. Mixtures of carboxanilide-type fungicidies can also be used.

Examples of carbamate type fungicides that are useful in the present invention include, without limitation, propamacarb and propamacarb hydrochloride. Mixtures of carbamate-type fungicidies can also be used.

Examples of anilinopyrimidine type fungicides that are useful include, without limitation, cyprodnil, mepanipyrim and pyrimethanil. Mixtures of anilinopyrimidine-type fungicidies can also be used.

Examples of benzimidazole type fungicides that are useful include, without limitation, benomyl, carbendazim, fuberidazole, and thiabendazole. Mixtures of benzimidazole-type fungicidies can also be used.

Examples of systemic type fungicides that are useful in the present invention include, without limitation, mefenoxam, metalaxyl-M, thiophanate-methyl, benalaxyl, cymoxanil, cyprofuram, furalaxyl, ofurace, oxadixyl, fosetyl-aluminium, phosphorous acid and its salts. Mixtures of systemic-type fungicidies can also be used.

Mixtures of fungicides are also contemplated. For example, and not for limitation, mixtures of systemic type fungicides in combination with benzimidazole-, anilinopyrimidine-, carbamate-, carboxanilide-, amide- and carboxamide-, phenylpyrrole-, strobilurin-, or triazole-type fungicides are contemplated.

Preferred fungicides include fludioxonil, picarbutrazox, mefenoxam, sedaxane, and thiabendazole.

Insecticides useful in the compositions include any agent useful for the prevention or treatment of damage caused by insect pests. Insecticides useful in the composition of the present invention include those classified as neonicotinoids, pyrethroids, phosphorus compounds, carbamates and others.

Examples of neonicotinoid insecticides that are useful include, without limitation, acetamiprid, clothianidin, dinotefuran, imidacloprid, nitenpyram, thiacloprid, thiamethoxam. Preferred neonicotinoid insecticides include clothianidil, imidacloprid and thiamethoxam. Mixtures of neonicotinoid insecticides are also contemplated. Particularly preferred neonicotinoid insecticides include thiamethoxam and imidacloprid.

Pyrethroid insecticides useful in the compositions include, without limitation, alpha-cypermethrin, beta-cyfluthrin, beta-cypermethrin, bifenthrin, bioallethrin, bioresmethrin, cycloprothrin, cyfluthrin, cyhalothrin, cypermethrin, cyphenothrin, deltamethrin, empenthrin, esfenvalerate, fenpropatluin, fenvalerate, flucythrinate, flumethrin, gamma-cyhalothrin, imiprothrin, lambda-cyhalothrin, methothrin, metofluthrin, permethrin, phenothrin, prallethrin, resmethrin, tau-fluvalinate, tefluthrin, tetramethrin, theta-cypennethrin, tralomethrin, transfluthrin, and zeta-cypermethrin. Preferred pyrethroid insecticides include tefluthrin and lambda cyhalothrin. Mixtures of pyrethroid insecticides are also contemplated.

Phosphorus insecticides useful in the compositions include, without limitation, phorate, phosalone, phosmet, phosphamidon, phoxim. Mixtures of phosphorus insecticides are also contemplated.

Carbamate insecticides useful in the compositions include, without limitation, pirimicarb, benfuracarb, carbaryl, carbofuran, carbosulfan, ethiofencarb, fenobucarb, formetanate, furathiocarb, isoprocarb, methiocarb, methomyl, metolcarb, oxamyl, propoxur, trimethacarb, 3,5-xylyl methylcarbamate, and xylylcarb. Mixtures of carbamate insecticides are also contemplated.

Mixtures of the classes of insecticides are also contemplated. For example, and not for limitation, carbamate insecticides may be mixed with pyrethroid, neonicotinoid, or phosphorus insecticides; pyrethroid insecticides may be mixed with carbamate, neonicotinoid, or phosphorus insecticides; neonicotinoid insecticides may be mixed with pyrethroid, phosphorus or carbamate insecticides; phosphorus insecticides may be mixed with neonicotinoid, carbamate, or pyrethroid insecticides.

In one embodiment, the composition includes about 0.75% w/w fludioxonil, about 0.75% w/w picarbutrazox, about 1% w/w mefenoxam, about 1.5% w/w sedaxane, and about 4.25% w/w thiabendazole. In a more specific embodiment, the composition includes 0.72% w/w fludioxonil, 0.72% w/w picarbutrazox, 1.07% w/w mefenoxam, 1.43% w/w sedaxane, and 4.3% w/w thiabendazole.

In one embodiment, the composition includes pydiflumetofen.

In one embodiment, the composition includes about 1% w/w fludioxonil, about 17% w/w thiamethoxam, about 2.5% w/w mefenoxam, about 1% w/w sedaxane, about 2% w/w thiabendazole, and about 0.5% w/w picarbutrazox. In a more specific embodiment, the composition includes 0.85% w/w fludioxonil, 17% w/w thiamethoxam, 2.56% w/w mefenoxam, 0.85% w/w sedaxane, 1.7% w/w thiabendazole, and 0.34% w/w picarbutrazox

In one embodiment, the composition includes about 10% w/w cyclobutrifluram, about 4% w/w fludioxonil, about 5% w/w difenoconazole, and about 4% w/w metalaxyl-M. In a more specific embodiment, the composition includes 10.43% w/w cyclobutrifluram, 4.35% w/w fludioxonil, 5.35% w/w difenoconazole, and 4.35% w/w metalaxyl-M.

### Application Rates

The compositions can be applied to seeds on an application rate based on volume per weight of seeds. In certain embodiments, the application rate is 100 to 2000 ml/100 kg of seed or in some embodiments 10-750 ml/100 kg of seed. In other embodiments, the application rate is about 100-500 ml/100 kg of seed.

### Surface Active Agent

The compositions can contain at least about 2% up to about 20% w/w of a surface-active agent. In one embodiment, the aqueous compositions contain from 3% up to about 10% w/w of a surface-active agent.

The surface active agent (a) comprises (a1) at least one anionic surfactant. In general, the anionic surfactant may be any known in the art. Suitable anionic surfactants are in general oligomers and polymers, as well as polycondensates, which contain a sufficient number of anionic groups to ensure their water-solubility. Suitable anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C12-C15 alkanols or polyalkoxylated C12-C15 alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-M-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Specific examples of suitable anionic surfactants include: Geropon T77 (Rhodia) (N-methyl-N-oleoyltaurate Na salt); Soprophor 4D384 (Rhodia) (tristyrylphenol sulphate); Reax 825 (Westvaco) (ethoxylated lignin sulfonate); Stepfac 8171 (Stepan) (ethoxylated nonylphenol phosphate ester); Ninate 401-A (Stepan) (calcium alkylbenzene sulfonate); Emphos CS-131 (Witco) (ethoxylated nonylphenol phosphate ester); and Atphos 3226 (Unigema) (ethoxylated tridecylalcohol phosphate ester). Suitable anionic surfactants can be prepared by methods known per se and also are commercially available.

The surface-active agent comprising a1) at least one anionic surfactant may optionally further comprise a2) one or more nonionic surfactants. As used herein, “nonionic surfactants” are different compounds from the water-dispersible and water-soluble polymers b) described herein.

Exemplary nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C8-C22 alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, and mono- and diesters of ethylene glycol and mixtures thereof.

Specific examples of suitable nonionic surfactants include: Genapol X-060 (Clariant) (ethoxylated fatty alcohol); Sorpohor BSU (Rhodia) ethoxylated tristyrylphenol; Makon TD-6 (Stepan) (ethoxylated fatty alcohol); BRIJ 30 (Unigema) (ethoxylated lauryl alcohol); Witconol CO-360 (Witco) (ethoxylated castor oil); and Witconol NP-60 (Witco) (ethoxylated nonylphenol). Suitable nonionic surfactants can be prepared by methods known per se and also are commercially available.

In addition to anionic and nonionic surfactants, certain cationic or zwitterionic surfactants a3) also are suitable for use in the present invention such as alkanol amides of C8-C18 fatty acids and C8-C18 fatty amine polyalkoxylates, C10-C18 alkyldimethylbenzylammonium chlorides, coconut alkyldimethylaminoacetic acids, and phosphate esters of C8-C18 fatty amine polyalkoxylates.

In one embodiment, a mixture of surfactants (a1), (a2) and optionally (a3) is employed as follows:
(1) 0.1-4% w/w of a wetting agent selected from (a1) at least one anionic surfactant. Suitable anionic surfactant wetting agents include sulfoalkylamides and salts thereof such as N-methyl-N-oleoyltaurate Na salt, alkylaryl sulfonates such as alkylbenzene sulfonates and alkylnaphthalene sulfonates and salts thereof and salts of ligninsulfonic acid;
(2)¹-10% w/w of a dispersing agent selected from (a1) at least one anionic surfactant. Suitable anionic surfactant dispersing agents include sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts;
(3) 1 to 10% w/w of an emulsifying agent selected from (a1) at least one anionic surfactant, (a2) at least one nonionic surfactant and a mixture thereof. Suitable anionic/nonionic surfactant emulsifiers include salts of ethoxylated alkylphenols, polyoxyethylene-polyoxypropylene alkylphenols, (fatty) alcohol ethoxylates and ethoxylated tristyrylphenols.

### Polymers

The composition can also include at least one polymer selected from water-soluble and water-dispersible polymers. Suitable polymers have an average molecular weight of at least about 1,000 up to about 100,000; more specifically at least about 5,000, up to about 100,000. The compositions generally contain from about 0.5% to about 10% w/w of the composition of polymer (b). In a specific embodiment, the compositions contain from about 1.0% up to about 5% w/w of a water-dispersible polymer.

Suitable polymers are selected from:
b1) alkyleneoxide random and block copolymers such as ethylene oxide-propylene oxide block copolymers (EO/PO block copolymers) including both EO-PO-EO and PO-EO-PO block copolymers;
ethylene oxide-butylene oxide random and block copolymers,
C2-6 alkyl adducts of ethylene oxide-propylene oxide random and block copolymers,
C2-6 alkyl adducts of ethylene oxide-butylene oxide random and block copolymers,
b2) polyoxyethylene-polyoxypropylene monoalkylethers such as methyl ether, ethyl ether, propyl ether, butyl ether or mixtures thereof.
b3) vinylacetate/vinylpyrrolidone copolymers,
b4) alkylated vinylpyrrolidone copolymers,
b5) polyvinylpyrrolidone, and
b6) polyalkyleneglycol including the polypropylene glycols and polyethylene glycols.

Specific examples of suitable polymers include Pluronic P103 (BASF) (EO-PO-EO block copolymer), Pluronic P65 (BASF) (EO-PO-EO block copolymer), Pluronic P108 (BASF) (EO-PO-EO block copolymer), Vinamul 18160 (National Starch) (polyvinylacetate), Agrimer 30 (ISP) (polyvinylpyrrolidone), Agrimer VA7w (ISP) (vinyl acetate/vinylpyrrolidone copolymer), Agrimer AL 10 (ISP) (alkylated vinylpyrrolidone copolymer), PEG 400 (Unigema) (polyethylene glycol), Pluronic R 25R2 (BASF) (PO-EO-PO block copolymer), Pluronic R 31R1 (BASF) (PO-EO-PO block copolymer) and Witconol NS 500LQ (Witco) (butanol PO-EO copolymer).

### Rheological Modifiers/Carriers

The composition can also comprise, at least about 0.1 and up to about 20% w/w, more specifically from 5 to about 15% w/w of at least one solid carrier.

The solid carrier is a natural or synthetic solid material that is insoluble in water. This carrier is generally inert and acceptable in agriculture, especially on the treated seed. It can be chosen, for example, from clay, diatomaceous earth, natural or synthetic silicates, titanium dioxide, magnesium silicate, aluminum silicate, talc, pyrophyllite clay, silica, attapulgite clay, kieselguhr, chalk, limestone, calcium carbonate, bentonite clay, Fuller's earth, and the like.

### Antifreeze

The composition can comprise, at least about 3 and up to about 25% w/w of at least one antifreeze agent, more specifically from 6 to about 20% w/w.

Specific examples of suitable antifreezes include ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol and the like.

As a particular subset of suitable antifreeze materials there can be mentioned ethylene glycol, propylene glycol and glycerin.

### Additional Components

The composition optionally contains at least one thickener.

In one embodiment, the thickener is present in the aqueous composition in an amount from about 0.010% to about 25% w/w, more specifically from 0.02 to 10% w/w.

Illustrative of thickeners (water-soluble polymers which exhibit pseudoplastic properties in an aqueous medium) are gum arabic, gum karaya, gum tragacanth, guar gum, locust bean gum, xanthan gum, carrageenan, alginate salt, casein, dextran, pectin, agar, 2-hydroxyethyl, starch, 2-aminoethyl starch, 2-hydroxyethyl cellulose, methyl cellulose, carboxymethyl cellulose salt, cellulose sulfate salt, polyacrylamide, alkali metal salts of the maleic anhydride copolymers, alkali metal salts of poly(meth)acrylate, and the like.

As suitable thickeners there may also be mentioned attapulgite-type clay, carrageenan, croscarmellose sodium, furcelleran, glycerol, hydroxypropyl methylcellulose, polystyrene, vinylpyrrolidone/styrene block copolymer, hydroxypropyl cellulose, hydroxypropyl guar gum, and sodium carboxymethylcellulose. Xanthan gum is preferred.

The composition according to the invention can be employed together with the adjuvants customary in formulation technology, biocides, biostats, emulsifiers (lethicin, sorbitan, and the like), antifoam agents or application-promoting adjuvants customarily employed in the art of formulation. In addition, there may be mentioned inoculants and brighteners.

Additionally, a coloring agent, such as a dye or pigment is included in the seed coating so that an observer can immediately determine that the seeds are treated. The dye is also useful to indicate to the user the degree of uniformity of the coating applied.

The inventive compositions contain and/or may be applied together or sequentially with further active compounds. These further compounds can be fertilizers or micronutrient donors or other preparations that influence plant growth. They can also be selective herbicides, insecticides, fungicides, bactericides, insect growth regulators, plant growth regulators, nematicides, molluscicides or mixtures of several of these preparations.

### Process

The compositions can be prepared by processes known in the art.

In one embodiment, the aqueous fungicidal compositions of the invention can be prepared by a process which comprises the steps: (a) forming a premix with at least one fungicidally active compound and at least one surfactant; (b) forming a premix of a carrier and water, and (c) sequentially adding the premixes (a) and (b) and the remaining ingredients to water while stirring to form a homogeneous composition.

In some embodiments, the process comprises: (a) preparing a concentrate and (b) diluting the concentrate with water or other diluent to reach desired concentration.

### Compositions

Compositions may take the form of aqueous solutions, dispersions, suspensions, emulsions or suspoemulsions. In one embodiment, the composition is a ready for use suspoemulsion.

The average size of the suspended particles is 0.1 to 20, specifically 1.5 to 5 microns when measured with a laser particle analyzer, e.g. a CILAS 920 apparatus.

The viscosity of the aqueous composition is 50 to 2000, more specifically 100 to 1000 mPas when measured with a BROOKFIELD viscometer with spindle 3 at 30 rpm and 25° C.

### Use

For the purposes herein, seed treatments are defined as chemical or biological substances that are applied to seeds or vegetative plant propagation materials to control disease organisms, insects, or other pests. The seed treatment composition of the invention includes fungicides, but can also include other pesticides such as bactericides and insecticides. Most seed treatments are applied to true seeds, which have a seed coat surrounding an embryo. However, some seed treatments can be applied to vegetative plant propagation materials such as rhizomes, bulbs, corms or tubers.

The compositions can be formulated for protecting cultivated plants and their propagation materials. The compositions are advantageously formulated for seed treatment applications against diseases in the soil, which mostly occur in the early stages of plant development. For example, the compositions can be formulated to target pathogens including Pythium, Tilletia, Gerlachia, Septoria, Ustilago, Fusarium, Rhizoctonia (so-called “damping off complex”); Oomycetes such as Phytophthora, Plasmopara, Pseudoperonospora, Bremia etc. as well as against the Botrytis species, Pyrenophora, Monilinia and further representatives of the Ascomycetes, Deuteromycetes and Basidiomycetes classes.

Suitable target crops are especially potatoes, cereals (wheat, barley, rye, oats, rice), maize, sugar beet, cotton, millet varieties such as sorghum, sun flowers, beans, peas, oil plants such as canola, rape, soybeans, cabbages, tomatoes, eggplants (aubergines), pepper and other vegetables and spices as well as ornamental shrubs and flowers.

Suitable target crops also include transgenic crop plants of the foregoing varieties. The transgenic crop plants used according to the invention are plants, or propagation material thereof, which are transformed by means of recombinant DNA technology in such a way that they are—for instance—capable of synthesizing selectively acting toxins as are known, for example, from toxin-producing invertebrates, especially of the phylum Arthropoda, as can be obtained from Bacillus thuringiensis strains; or as are known from plants, such as lectins; or in the alternative capable of expressing a herbicidal or fungicidal resistance. Examples of such toxins, or transgenic plants which are capable of synthesizing such toxins, have been disclosed, for example, in EP-A-0 374 753, WO 93/07278, WO 95/34656, EP-A-0 427 529 and EP-A-451 878 and are incorporated by reference in the present application.

The inventive compositions are particularly suited for dressing applications on plant propagation material. The preferred field of application is the treatment of all kinds of seeds (as specified in the target crops above), and in particular the seed treatment of canola, maize, cereals, soybeans and other legumes and crops that are susceptible.

The techniques of seed treatment application are well known to those skilled in the art, and they may be used readily in the context of the present invention. The compositions of the invention is applied to the seed as slurry or a soak. There also may be mentioned, e.g., film coating or encapsulation. The method of application of the compositions to the seed may be varied and the invention is intended to include any technique that is to be used.

One method of applying the composition according to the invention consists in spraying or wetting the plant propagation material with the aqueous liquid preparation, or mixing the plant material with such liquid preparation. Also, before the application, the composition of the invention may be diluted with water by simple mixing at ambient temperature in order to prepare an on-farm seed treatment formulation.s

In one embodiment a concentrate or dilute composition of the invention is applied to seed by spraying, wetting or mixing in a volume of from 200 ml to 3 liters of aqueous composition per 100 kg of seed, more specifically, from 400 ml to 2 liters of aqueous composition per 100 kg of seed.

As noted above, the compositions of this invention may be formulated or mixed in the seed treater tank or combined on the seed by overcoating with other seed treating agents. The agents to be mixed with the compounds of this invention may be for the control of pests, nutrition, and the control of plant diseases.

### EXAMPLES

The following examples illustrate some further aspects of the invention but are not intended to limit its scope. Where not otherwise specified throughout this specification and claims, percentages are w/w.

### Example 1: Preparation of Treated Propagation Material

Two formulations were prepared having the components in Table 1.

TABLE 1

| Material | Formulation 1 | Formulation 2 |
|---|---|---|
| Cyclobutrifluram | 10.43 | 10.43 |
| Fludioxonil | 4.35 | 4.35 |
| Difenoconazole | 5.35 | 5.35 |
| Metalaxyl-M | 4.31 | 4.31 |
| Soybean Oil | 7.24 | 0 |
| Antifreeze | 7.2 | 7.2 |
| Dispersant Package | 10.081 | 10.081 |
| Wetting Agent | 0.52 | 0.52 |
| Pigment Dispersion | 20.69 | 20.69 |
| Antifoam | 0.34 | 0.34 |
| Bentonite Clay | 0.31 | 0.31 |
| Rheology Modifier | 0.012 | 0.012 |
| Preservatives | 0.122 | 0.122 |
| Buffer Agents | 0.071 | 0.071 |
| Silicone Emulsion | 0 | 3.62 |
| MASIL ® EM 10,000 C (DYSTAR)) | | |
| Micronized Wax | 0 | 3.62 |
| (Nurture Yield ® S 2002 (Michelman)) | | |
| Water | 28.973 | 28.973 |

Formulations 1 and 2 were diluted to form slurries having 500 mL/100 kg and applied NK S74-M3 soybeans. NurtureYield® S 2002 is a natural wax emulsion, where the natural wax is carnauba wax. Application was done with a rotostat treater (Aginnovation Rotary-12); having an injection time of approximately 5 seconds, and then mixing for 12 seconds before ejecting seeds.

### Example 2: FT4 Flowability Test

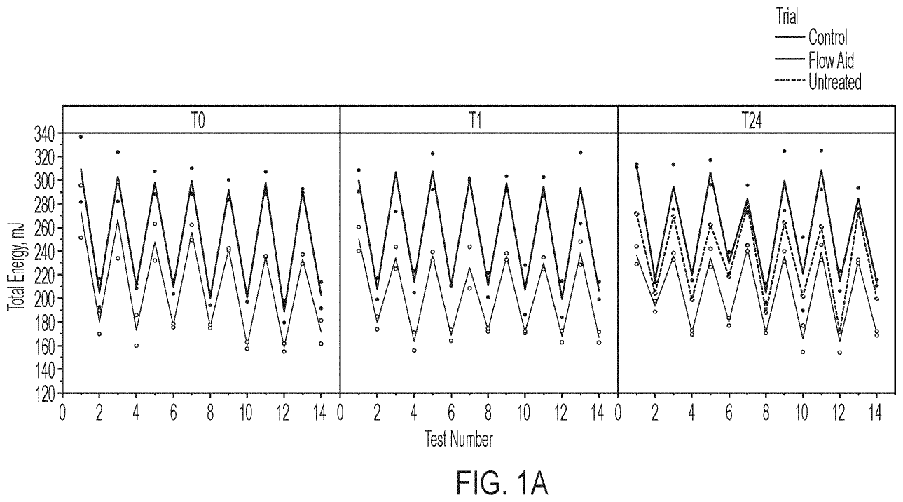

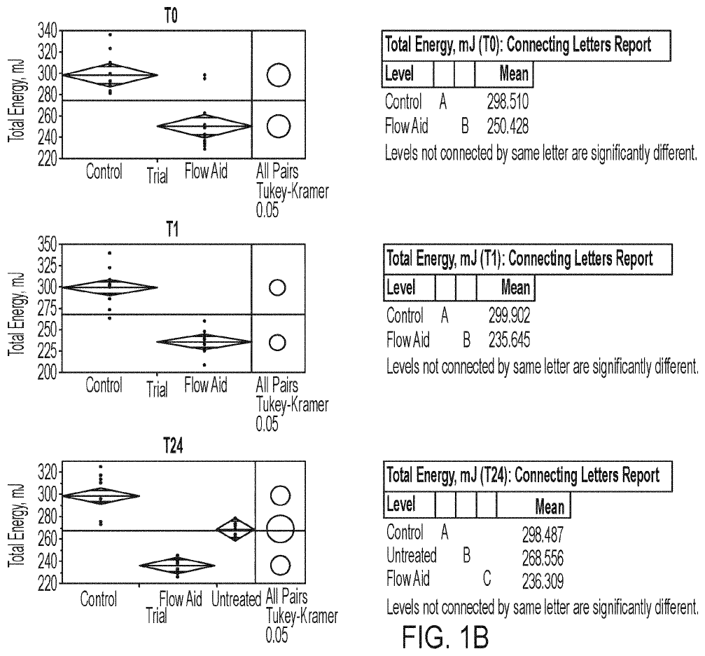

Seeds treated with Formulation 1 and 2 were tested for flowability in a FT4 Powder Rheometer fitted with 23.5 mm blade and 62×120 ml split vessel. The rheometer ran a standard flowability test to measure the total energy of the blade moving through seeds (blade moving in reverse direction) with a conditioning step and an up-down cycle repeated for 7 reps. The test was ran immediately after application (T0), 1 hour after (T1), and 24 hours after (T24). At T24 untreated seeds were tested. The results are provided in FIG. 1A. The rheometer measured less total energy from seeds treated with the flow aid across all time intervals indicating improved flowability, i.e., less energy was required to move the blade through the seeds. In the test, Formulation 2 performed better than untreated seeds at T24.

FIG. 1B shows the statistical analysis when looking only at the down reps. This is because the blade experiences more force going down into the vessel of seeds. As illustrated, seeds treated with the flow aid had significantly lower total energy than the control and untreated seeds. Notably, the alternative flow aid and control are still significantly different when both up and down reps are included.

### Example 3: Change in Slurry

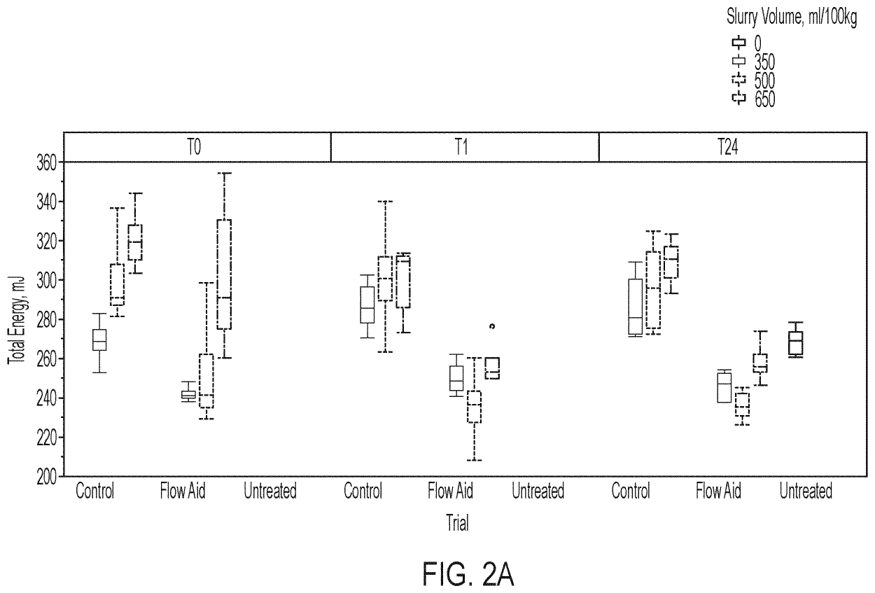

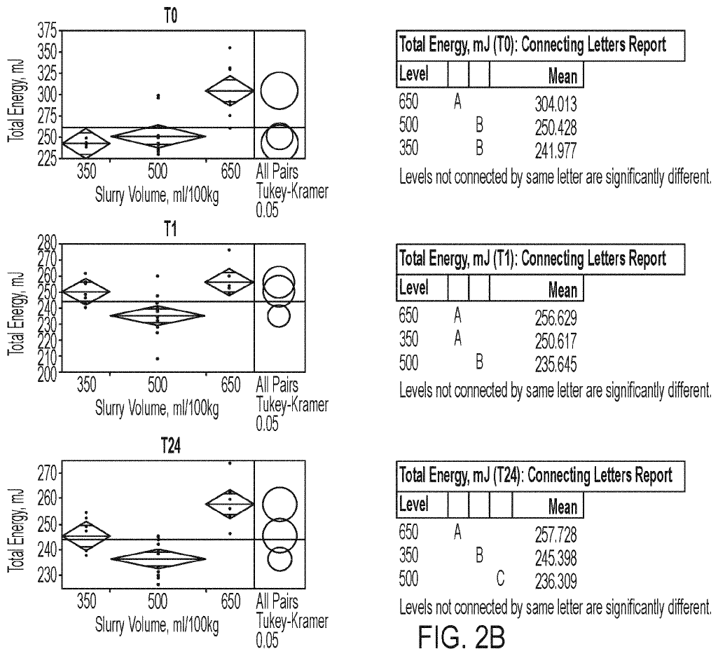

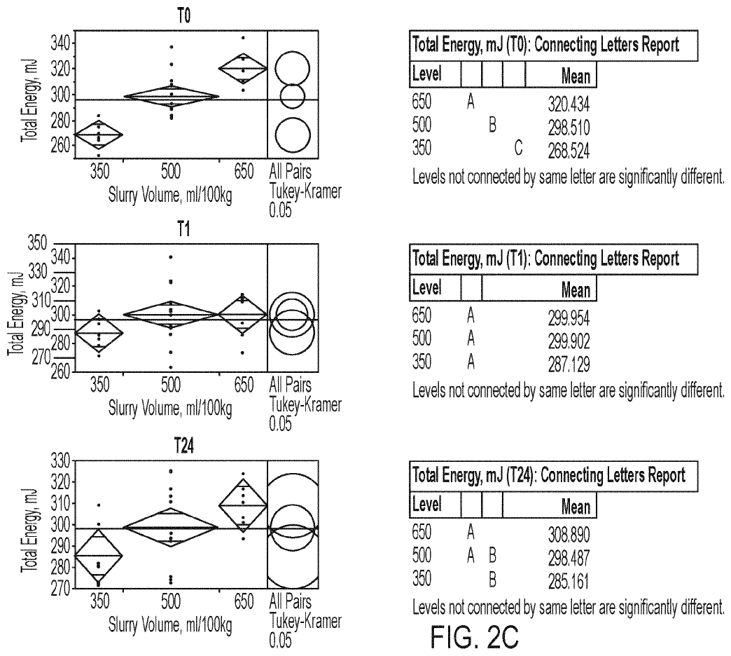

Formulations 1 and 2 were analyzed to determine the differences in flow aid when slurry volume changes. Formulations 1 and 2 were each diluted to 350 ml/100 kg, 500 ml/100 kg, and 650 ml/100 kg, and untreated. Each formulation was tested in the rheometer, the results of which are summarized in FIG. 2A. In FIG. 2A, the results include both the up rep and down rep resulting in larger bars.

FIG. 2B shows the statistical analysis when looking only at the down reps for the various dilutions of Formulation 2. As illustrated, at T0, 650 ml/100 kg slurry volume exhibits higher total energy than 350 and 500 ml/100 kg resulting in worse flow at higher slurry volumes on the wet seeds. However, once the seeds dried, at T1 and T24, 500 ml/100 kg slurry volume has lower total energy, being significantly different than 350 and 650. This indicates higher slurry volume, adding more water, has some impact on flow aid.

FIG. 2C shows the statistical analysis when looking only at the down reps for the various dilutions Formulation 1. At T0, the control has significantly different total energy at each slurry volume, with 350 ml/100 kg having the lowest total energy. At T1 there is no significant difference between the slurry volumes and at T24, there is only a significant difference between 350 and 650 ml/100 kg.

### Example 4: Dust Off and DMA Testing

The various dilutions of Formula 1 and 2 were tested for their dust off properties. Two repetitions of a QC dust test (100 g of seeds, 120 seconds, 20 L/min, 30 rpm) using a Heubach was performed on dry seeds. The results are provided in Tables 2 and 3.

TABLE 2
QC Dust, g/100 kg

| Composition | | Mean |
|---|---|---|
| Control, 500 ml/100 kg | A | 0.2 |
| Control, 650 ml/100 kg | A | 0.2 |
| Flow Aid, 500 ml/100 kg | A | 0.15 |
| Control, 350 ml/100 kg | A | 0.05 |
| Flow Aid, 650 ml/100 kg | A | 0.05 |
| Flow Aid, 350 ml/100 kg | A | 0 |

*Levels not connected by same letter are significantly different

TABLE 3
QC Dust, g/100 kg

| Composition | | Mean |
|---|---|---|
| Control | A | 0.15 |
| Flow Aid | A | 0.067 |

*Levels not connected by same letter are significantly different

There was no negative impact on the dust with the addition of the alternative flow aid and slurry volumes.

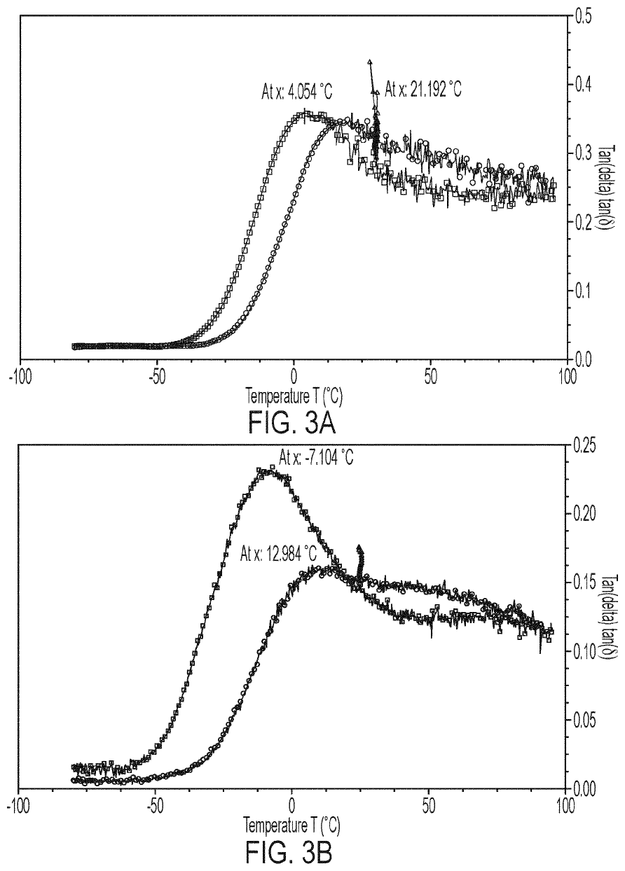

The coated seeds were additionally tested using dynamic mechanical analysis (DMA). The results are shown in FIGS. 3A and 3B. FIG. 3A shows the results for Formulation 1 wherein wet is Tg: 4.05 C and dry is Tg: 21.19 C and FIG. 3B shows the results for Formulation 2 wherein wet Tg is −7.10 C and dry Tg is 12.98 C.

### Example 5: Funnel Flow Study

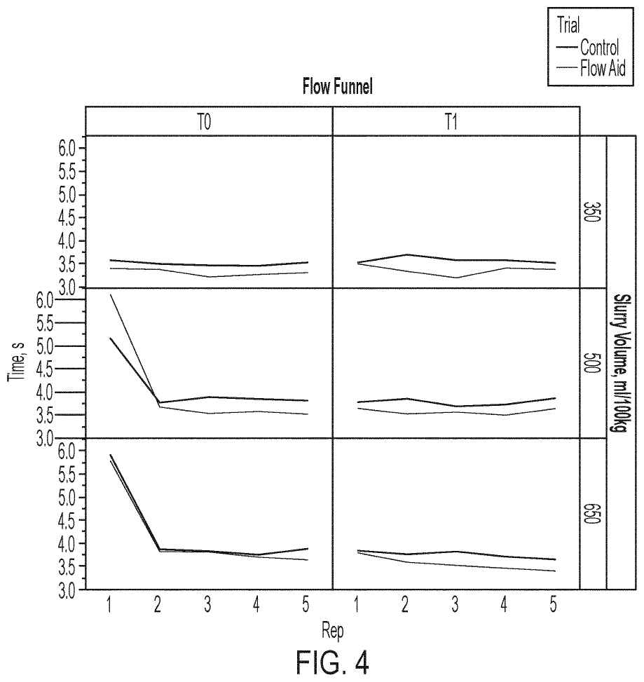

The various dilutions of Formulations 1 and 2 were tested for their flowability in a funnel test. Five repetitions of 500 g of seed were put in funnel for 1 minute before being allowed to flow through the funnel. The time it took for the seeds to leave funnel was measured. The tests were run after application (T0) and 1 hour (T1) after application. The results are provided in Table 4 and FIG. 4.

TABLE 4

time (s)

| | | T0 | T1 |
|---|---|---|---|
| Slurry vol. | Trial | Mean | Mean |
| 350 | Control | 3.508 | 3.582 |
| | Flow Aid | 3.316 | 3.366 |
| 500 | Control | 4.097 | 3.784 |
| | Flow Aid | 4.084 | 3.575 |
| 650 | Control | 4.248 | 3.756 |
| | Flow Aid | 4.15 | 3.552 |

As seen in FIG. 4, blockages occurred in the first repetitions for the alternative flow aid and control at 500 and 650 ml/100 kg slurry volumes. However, once a stable flow was established, the flow aid saw better flow for both wet and dry seeds. As illustrated, seeds treated with the alternative flow aid had faster flow times than the control.

### Example 6: Preparation of Treated Propagation Material

Three formulations were prepared having the components in Table 5.

TABLE 5

| | Formu- | Formu- | Formu- |
|---|---|---|---|
| Component | lation 3 | lation 4 | lation 5 |
| Fludioxonil | 0.851 | | |
| Thiamethoxam | 17.040 | | |
| Mefenoxam | 2.560 | | |
| Sedaxane | 0.851 | | |
| Thiabendazole | 1.703 | | |
| Picarbutrazox | 0.339 | | |
| Dispersant System | 7.058 | | |
| Polyethylene glycol isodecyl ether | 0 | | 0.200 |
| Wetting Agent | 0.372 | | |
| Soybean oil | 8.025 | | 0 |
| MICROKLEAR ® 418 (Carnauba | 0 | | 5.000 |
| wax) | | | |
| Pigment Dispersion | 16.000 | | |
| Biocide System | 0.083 | | |
| Thickener | 0.090 | | |
| Clay | 0.446 | | |
| Buffer | 0.041 | | |
| MASIL ® EM 10,000 C | 0 | 0.995 | |
| (Silicone emulsion) | | | |
| Antifoam | 0.040 | 0.003 | |
| Antifreeze system | 2.113 | | |
| Potable Water | 36.644 | 35.686 | 38.511 |
| Total | 100.000 | 100.000 | 100.000 |

Formulations 4 and 5 require less anti-foam agent because the silicone emulsion can additionally function as an anti-foam agent. Polyethylene glycol isodecyl ether is included in Formulation 5 as a specific wetting agent for carnauba wax. The formulations were applied to soybeans for testing.

### Example 7: FT4 Flowability Test

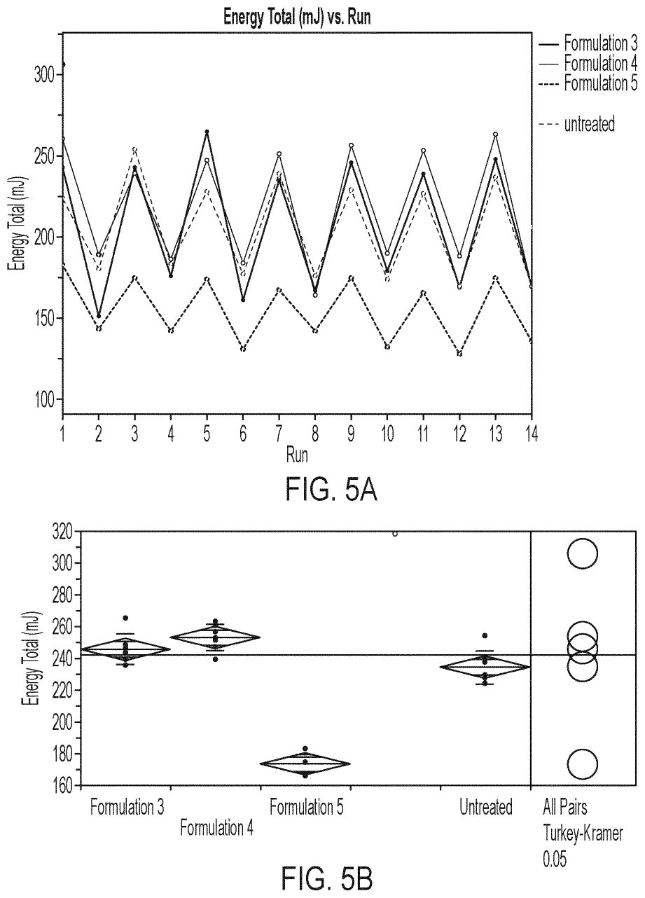

Seeds treated with Formulations 3-5 and untreated seeds, were tested for flowability in a FT4 Powder Rheometer. The results are summarized in Table 6 and FIGS. 5A and B.

TABLE 6

| Treatment | | | | Mean |
|---|---|---|---|---|
| Formulation 4 | B | | | 252.86 |
| Formulation 3 | B | C | | 245.57 |
| Untreated | | C | | 234 |
| Formulation 5 | | | D | 173.57 |

*Levels not connected by same letter are significantly different

FIG. 5A provides the results of each cycle during testing. FIG. 5B and Table 6 shows the statistical analysis when looking only at the down reps. As illustrated, Formulation 5 required less energy than the untreated seeds and comparable formulations having either soybean oil as the flow aid or a silicone emulsion.

### Example 8: Funnel Test

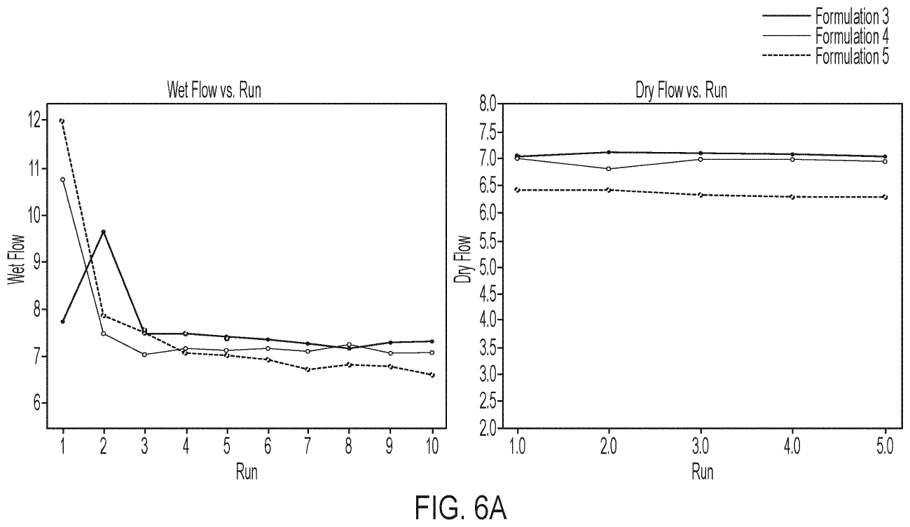

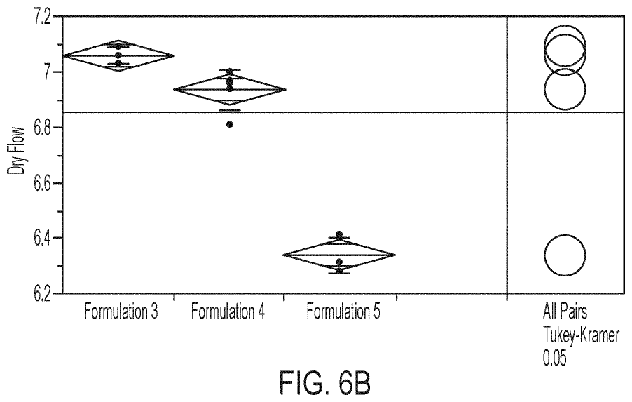

Seeds treated with Formulations 3-5 were tested for their flowability in a funnel test for both wet and dry seeds. The test looked to see how long it takes a set amount of seeds to pass through a funnel. The results are summarized in Table 7 and FIGS. 6A and B.

TABLE 7

| Treatment | | | | Mean (sec) (dry) |
|---|---|---|---|---|
| Formulation 3 | A | | | 7.060 |
| Formulation 4 | | B | | 6.936 |
| Formulation 5 | | | C | 6.336 |

*Levels not connected by same letter are significantly different

As seen in FIG. 6A, blockages generally occurred in the first repetitions of wet seeds. However, as illustrated, Formulation 5 flowed better than comparable formulations having either soybean oil as the flow aid or a silicone emulsion.

### Example 9: Funnel Test

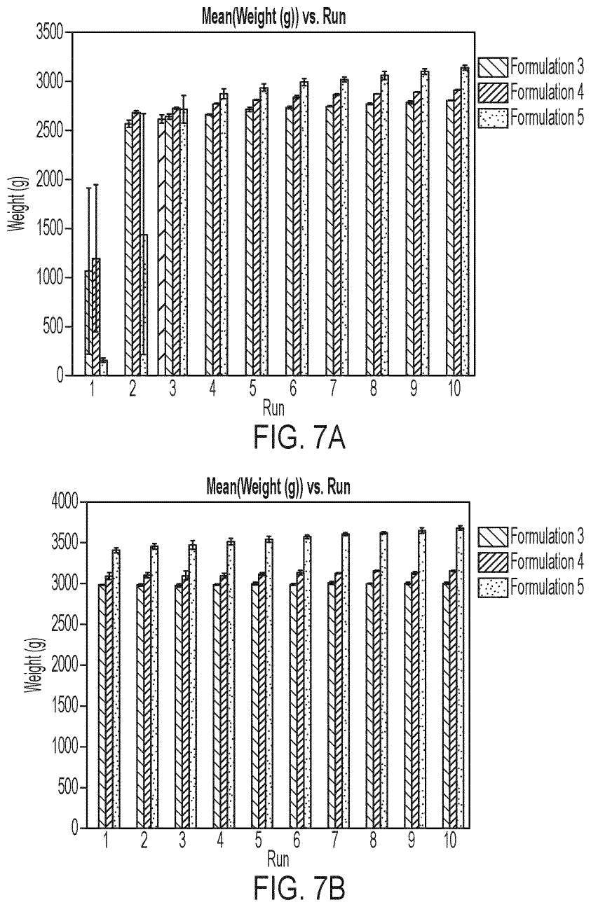

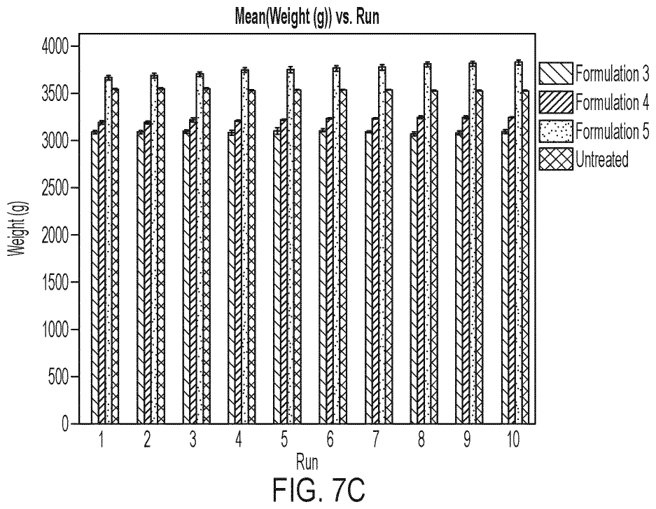

Seeds treated with Formulations 3-5, were tested for their flowability in a funnel test. The test was ran immediately after application (T0), 1 hour after (T1), and 24 hours after (T24). Untreated seeds were tested at the T24 testing. In the test, the seeds were allowed to sit in the funnel for one minute, after which, the gate was opened for 2 seconds intervals. The results are provided in FIGS. 7A-C: FIG. 7A corresponds to T0; FIG. 7B corresponds to T1; and FIG. 7C corresponds to T24. As indicated in FIG. 7A, blockages occurred in the initial tests. Formulation 5 flowed better than untreated seeds, and comparable formulations having either soybean oil as the flow aid or a silicone emulsion.

### Example 10: Plantability with Kinze Brush Meter Plate

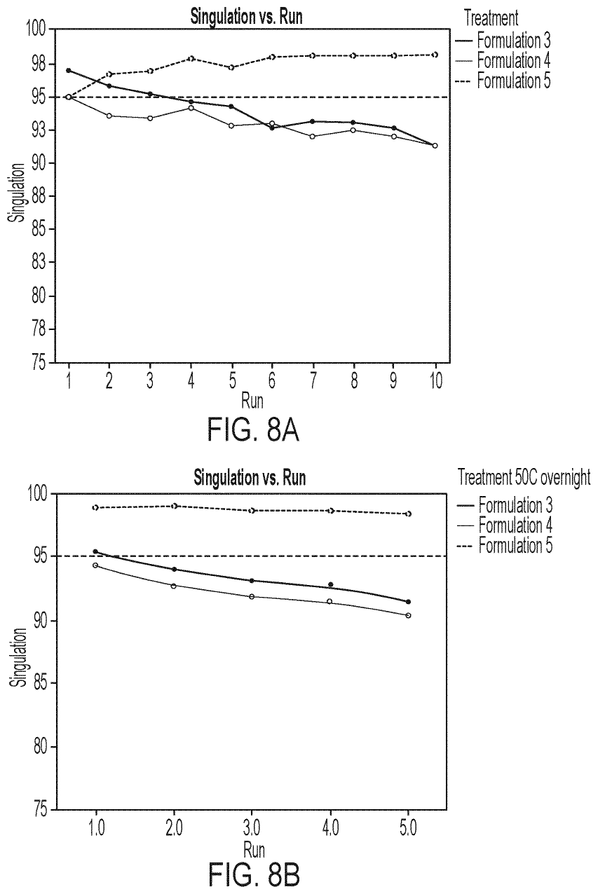

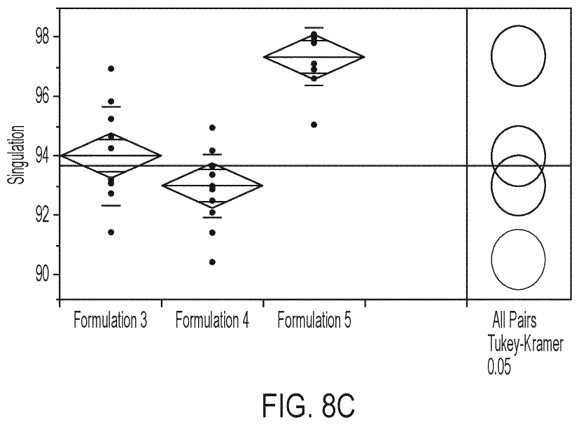

Seeds treated with Formulations 3-5 were tested for their singulation with a Kinze brush meter plate. The coated seeds were tested: (1) after drying and (2) after overnight exposure at 50° C. The results are summarized in Table 8 and FIGS. 8A-C.

TABLE 8

| Treatment | | | Mean |
|---|---|---|---|
| Formulation 5 | A | | 97.34 |
| Formulation 3 | | B | 93.93 |
| Formulation 4 | | B | 92.92 |

As illustrated, Formulation 5 had significantly better singulation than the commercial treatment and comparable formulations having either soybean oil as the flow aid or a silicone emulsion with wax.

### Example 11: Box-to-Box Seed Flow

Soybeans treated with Formulations 3 and 5 were tested at larger scales in a box to box transfer. Box to box testing differs from funnel testing in that seeds are not guided through a gradually narrower opening. Rather, seeds are transferred through an immediate opening in the box. Box to box testing focuses on measuring flowability and bridging between seeds as opposed to flowability against container surfaces. Results are expressed in flow of pounds of seed per second. Seeds treated with Formulations 3 and 5 were tested at T0 and T24. No flow clogging occurred in either testing. At T0, seeds treated Formulation 3 and 5 provided a flow of 63.19 and 63.31, respectively, and at T24, seeds treated with Formulation 3 and 5 provided a flow of 64.43 and 64.69. Accordingly, there were no adverse effects on seed to seed friction.

### Example 12: John Deere Vacuum Planter Test

Seeds treated with Formulations 3 and 5 were tested in a John Deere Vacuum Planter set at a ground speed of 10 mph, vacuum at 15 in H₂O, precision plate for Soybean (108 cell). 2000 seeds, having a seed size of 2900 seeds/lb, were tested at 72° F. and 65% relative humidity and 55° F. and 85% relative humidity with and without 11.012 g of talc (per 20 lbs of seed). The results are provided in Tables 9 and 10.

TABLE 9

| | John Deere Plantability (Ambient) | | | |
|---|---|---|---|---|
| | 72° F. and 65% RH | | | |
| | Formu- | Formu- | Formu- | Formu- |
| | lation | lation | lation 3 | lation 5 |
| | 3 with | 5 with | without | without |
| | lubricant | lubricant | lubricant | lubricant |
| Singulation (%) | 96.98 | 96.65 | 95.86 | 96.22 |
| Skips (%) | 1.57 | 1.89 | 2.52 | 2.2 |
| Multiples (%) | 1.46 | 1.46 | 1.62 | 1.58 |

TABLE 10

| | John Deere Plantability (Conditioned) | | | |
|---|---|---|---|---|
| | 55° F. and 85% RH | | | |
| | Formu- | Formu- | Formu- | Formu- |
| | lation | lation | lation 3 | lation 5 |
| | 3 with | 5 with | without | without |
| | lubricant | lubricant | lubricant | lubricant |
| Singulation (%) | 96.41 | 96.46 | 95.43 | 95.65 |
| Skips (%) | 1.98 | 1.88 | 2.79 | 2.5 |
| Multiples (%) | 1.6 | 1.66 | 1.78 | 1.85 |

As illustrated, seeds treated with Formulation 5 were able to function in a vacuum planter under various conditions.

### Example 13: Kinze Brush Meter Test

Plantability was tested in precision planter having a Kinzer brush meter. The planter was set to a ground speed of 5 mph and had finger plate for soybean (60 cell). 2000 seeds, having a seed size of 2900 seeds/lb, were tested at 72° F. and 65% relative humidity and 55° F. and 85% relative humidity with and without 5.179 g of talc (per 20 lbs of seed). The results are provided in Tables 11 and 12.

TABLE 11

| | Kinze Plantability (Ambient) | | | |
|---|---|---|---|---|
| | 72° F. and 65% RH | | | |
| | Formu- | Formu- | Formu- | Formu- |
| | lation | lation | lation 3 | lation 5 |
| | 3 with | 5 with | without | without |
| | lubricant | lubricant | lubricant | lubricant |
| Singulation (%) | 97.75 | 97.79 | 97.32 | 96.8 |
| Skips (%) | 0.03 | 0.02 | 0.19 | 0.01 |
| Multiples (%) | 2.22 | 2.19 | 2.5 | 3.2 |

TABLE 12

| | Kinze Plantability (Conditioned) | | | |
|---|---|---|---|---|
| | 55° F. and 85% RH | | | |
| | Formu | Formu- | Formu- | Formu- |
| | lation | lation | lation 3 | lation 5 |
| | 3 with | 5 with | without | without |
| | lubricant | lubricant | lubricant | lubricant |
| Singulation (%) | 96.35 | 98.75 | 96.18 | 97.48 |
| Skips (%) | 0.18 | 0.12 | 1.89 | 0.05 |
| Multiples (%) | 3.47 | 1.12 | 1.94 | 2.47 |

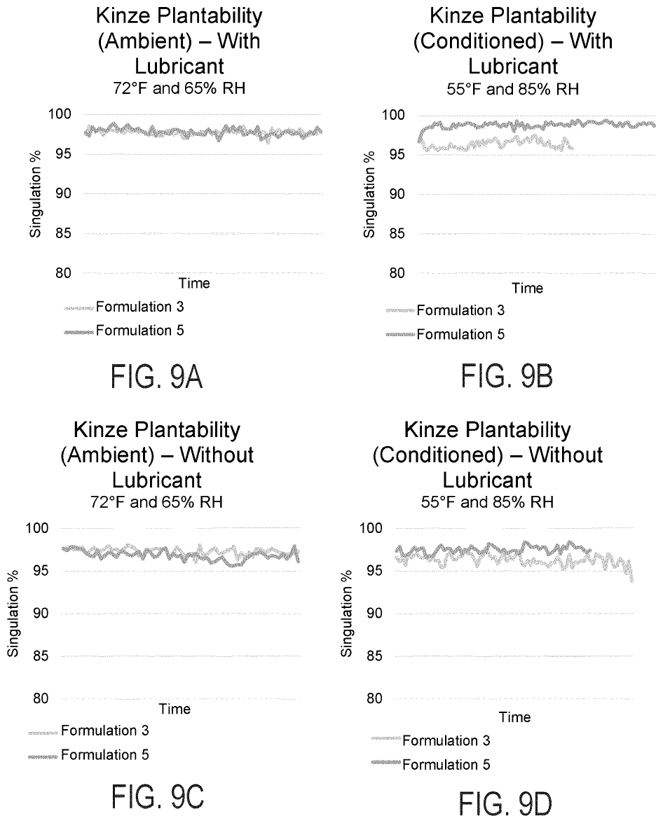

Formulation 5 provided improved Kinze brush meter plantability under climate conditions (55° F./85% RH) with and without seed lubricant. The above results are further shown in FIGS. 9A-D.

### Example 14: Dust-Off Testing

Formulations 3 and 5 were tested for dust-off properties. Both formulations had sufficient dust-off, below 0.5 g per 100 Kg/(2 min).

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

1. A composition, comprising:
an agrochemical active ingredient;
a micronized wax; and
a silicone emulsion.

2. The composition of claim 1, wherein the composition is formulated as a seed treatment.

3. The composition of claim 2, wherein the micronized wax is carnauba wax or a derivative thereof.

4. The composition of claim 3, wherein the micronized wax is present between about 1 to 15% w/w.

5. The composition of claim 4, wherein the micronized wax is present between about 2 to 10% w/w.

6. The composition of claim 5, wherein the micronized wax is present between about 4 to 6% w/w.

7. The composition of claim 2, wherein the silicone emulsion is present at about 0.05 to 4% w/w.

8. The composition of claim 7, wherein the silicone emulsion is present at about 1% w/w.

9. The composition of claim 2, wherein the average particle size of the micronized wax is 1 to 20 μm.

10. The composition of claim 2, wherein the micronized wax has a composition comprising: about 40% aliphatic esters (C26-C30), about 21% diesters of 4 hydroxycinnamic acid, about 13% ω-hydroxycarboxylic acids, and about 12% fatty alcohols.

11. The composition of claim 2, wherein the silicone in the silicone emulsion has a molecular weight greater than 350 g/mol.

12. The composition of claim 2, wherein the silicone in the silicone emulsion has a molecular weight greater than 6000 g/mol.

13. The composition of claim 2, wherein the silicone in the silicone emulsion has a molecular weight greater than about 10,000 g/mol.

14. The composition of claim 13, wherein the silicone is a polydimethylsiloxane.

15. A method of protecting a plant propagation material, comprising: applying a composition of claim 2 to a seed.

16. A composition, comprising:
an agrochemical active ingredient;
a micronized wax; and
a silicone.

17. The composition of claim 16, wherein the composition comprises:
about 5-30% w/w total agrochemical active ingredient;
about 0.5-4% w/w silicone;
about 1-15% w/w micronized wax;
about 1-20% w/w an antifreeze agent;
about 1-25% w/w a pigment dispersion;
less than 1% w/w a biocide system;
less than 1% w/w a rheology modifier; and
about 10-50% w/w water.

18. The composition of claim 17, wherein the silicone has a molecular weight greater than 6000 g/mol and is a polydimethylsiloxane; and
the micronized wax has a composition comprising: about 40% aliphatic esters (C26-C30), about 21% diesters of 4 hydroxycinnamic acid, about 13% ω-hydroxycarboxylic acids, and about 12% fatty alcohols.
